(19) United States
(12) Patent Application Publication
(10) Pub. No.: US 2005/0172311 A1
(43) Pub. Date: Aug. 4, 2005

(54) Terminal and associated method and computer program product for monitoring at least one activity of a user

(75) Inventors: Kari Hjelt, Espoo (FI); Jonni Friman, Hameenlinna (FI); Jyrki Jarvi, Helsinki (FI); Santtu Naukkarinen, Espoo (FI); Jarkko Ollikainen, Hyvinkaa (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/871,176

(22) Filed: Jun. 18, 2004

Related U.S. Application Data
(60) Provisional application No. 60/540,607, filed on Jan. 31, 2004.

(51) Int. Cl. H04N 7/173; H04H 9/00; H04N 7/16

(52) U.S. Cl. 725/10; 725/12

(57) ABSTRACT

A terminal is provided for monitoring at least one activity of a user. The terminal includes a connecting means, at least one acceleration sensor and a controller. The connecting means, which can include a strap, belt, clip, lanyard or the like, is adapted for attaching the terminal onto a body of the user. The acceleration sensor(s) are capable of measuring and providing acceleration measurement signals representative of movement of the user in performing an activity. And the controller is capable of operating an activity detection application, which is capable of receiving at least a portion of the measurement signals. The activity detection application is also capable of determining at least one value related to the user performing the selected activity based upon the acceleration measurement signals, the at least one value being an intensity value representing an intensity with which the user performs the activity.

### CROSS-REFERENCE TO RELATED APPLICATIONS

The present application claims priority from U.S. Provisional Patent Application Ser. No. 60/540,607, entitled: SYSTEM AND ASSOCIATED TERMINAL, METHOD AND COMPUTER PROGRAM PRODUCT FOR MONITORING AT LEAST ONE ACTIVITY OF A USER, filed on Jan. 31, 2004, the contents of which are incorporated herein by reference in its entirety.

### FIELD OF THE INVENTION

The present invention generally relates to systems and methods for monitoring activities of a user and, more particularly, relates to terminals and associated methods and computer program products for monitoring and tracking fitness activities of a user.

### BACKGROUND OF THE INVENTION

People follow exercise programs for a variety of reasons. These reasons include maintaining general well-being, assisting a weight loss program and preparation for a particular sporting event, such as a marathon. Such programs need to be carefully formulated and managed if the desired effect is to be achieved, and the exerciser is to avoid injury. It is known, for example from U.S. Pat. No. 6,635,013, to use a computer to provide a user with an exercise program. However, this system merely provides printed static instructions. Consequently, a person who requires more interactive exercise program development must employ a personal fitness trainer, which can be inconvenient and costly.

Systems and apparatuses have been developed to provide a fitness program that is cost-effective and convenient. One such apparatus is disclosed by Great Britain (GB) Patent Application No. 0326387.8, entitled: Apparatus and Method for Providing a User with a Personal Exercise Program, filed Nov. 12, 2003, the contents of which are hereby incorporated by reference in its entirety. As disclosed by GB 0326387.8, an exercise assistance apparatus includes a user interface, which can comprise a wireless communication receiver, and a processor, which can comprise a mobile phone. The apparatus is configured for generating an exercise program based upon physical parameters, such as physiological information (e.g., information relating to aerobic fitness) of a user, where the exercise program can include aerobic fitness and/or strength enhancing exercises. The apparatus can also be configured for controlling the user interface to provide guidance to the user during performance of a generated program.

The apparatus can be configured to generate a program that includes a plurality of exercise definitions, each including a variable exercise duration parameter. The apparatus can set the variable parameter based upon the physiological information, such as the input information relating to aerobic fitness. The apparatus can also be configured to compute an exercise duration by multiplying a base duration by an aerobic fitness value for the user. The aerobic fitness value, in turn, can be determined based upon the input physiological information, and thereafter modified, such as at predetermined times (e.g., intervals of three to eight weeks), based upon physiological information that can be input at the end of an exercise of the generated program. More particularly, for example, the aerobic fitness value can be modified by determining an expected performance, determining actual performance from the physiological information received after exercises, comparing the expected and actual performances, and thereafter increasing or decreasing the aerobic fitness value based upon the comparison.

The apparatus can also be configured to generate a program by selecting a mix of exercises of different intensity classes, where the ratios of the mix of intensities are determined by the aerobic fitness value. If so desired, the ratios can be further determined based upon the number of exercise sessions per week in the generated program. The apparatus can be configured to select a varied selection of exercises in an intensity class from a predetermined list of exercises, such as by selecting exercises for a terminal period of the program that represent a reduction in intensity.

The apparatus can further be configured to generate a program by selecting exercises based upon a strength value, where the strength value can be determined based upon the input physiological information. In such instances, the apparatus can be configured to select exercises for the program that become successively harder during the program. And as indicated above, the apparatus can be configured to determine a varied selection of exercises from a predetermined list of exercises.

Whereas an apparatus such as that disclosed by GB 0326387.8 adequately provides a fitness program that is cost-effective and convenient. It is always desirable to improve upon such apparatuses. Thus, it would be desirable to design an activity monitor capable of deriving physiological information relating to a user performing an exercise, where the activity monitor includes a means for wirelessly communicating the derived physiological information, such as to an exercise assistance apparatus like that disclosed by GB 0326387.8.

### SUMMARY OF THE INVENTION

In light of the foregoing background, embodiments of the present invention provide a terminal and associated method and computer program product for monitoring at least one activity of a user. Although the user typically comprises a person, in accordance with embodiments of the present invention, the user can alternatively comprise any of a number of entities capable of performing one or more activities. For example, the user can comprise a dog, cat, horse, rabbit, goat or other animal capable of performing one or more activities, many activities being performed much like a person.

Embodiments of the present invention are capable of monitoring the fitness activities of a user, and enabling the user to manage his or her personal fitness goals. In this regard, the terminal is capable of recognizing movements of the terminal, the movements being representative of movements of the terminal user in performing one or more activities. Based upon the movement of the user, the terminal is capable of tracking information regarding the activit(ies) performed by the user. For example, the terminal is capable of tracking the user's calorie consumption based upon personal information and an activity type. The information regarding the activit(ies) performed by the user can then be used, such as to monitor the information relative to personal fitness goals, with the terminal storing the information for subsequent use, if so desired. The terminal is capable of being embodied in a portable package that can be placed in relatively close proximity to the user, such as by being carried, belted, clipped or otherwise attached to or within the immediate proximity of the user.

According to one aspect of the present invention, a terminal is provided for monitoring at least one activity of a user. The terminal includes a connecting means, at least one acceleration sensor and a controller. The connecting means, which can comprise a strap, belt, clip, lanyard or the like, is adapted for attaching the terminal onto a body of the user. The acceleration sensor(s) are capable of measuring and providing acceleration measurement signals representative of movement of the user in performing an activity. The acceleration sensor(s) can be capable of measuring and providing acceleration measurement signals with a given sampling frequency. In various instances, then, an activity detection application, which is capable of being operated by the controller, is capable of dynamically adjusting the sampling frequency of the acceleration sensor(s) to thereby control power consumption of the terminal.

As indicated above, the controller is capable of operating an activity detection application. The activity detection application, in turn, can be capable of receiving a selection of an activity and at least a portion of the measurement signals. The activity detection application can also capable of determining at least one value related to the user performing the selected activity based upon the acceleration measurement signals and possibly the selected activity, at least one value comprising an intensity value representing an intensity with which the user performs the activity. Also, for example, the activity detection application can be capable of determining an energy expended by the user in performing the activity, a duration over which the user performs the activity, and/or a speed of the user in performing the activity. Additionally or alternatively, the activity detection application can be capable of determining a number of steps taken by the user in performing the activity, and/or a distance over which the user performs the activity.

Irrespective of the value(s) determined by the activity detection application, the activity detection application can also be capable of determining a position and/or a posture of the terminal to thereby facilitate identifying when the terminal is operating during at least one period of inactivity of the user. Additionally or alternatively, the activity detection application can be capable of receiving a selection of an activity automatically detectable by the activity detection application. In such instances, the activity detection application can also be capable of automatically detecting an activity performed by the user before determining at least one value. For example, the activity detection application can be capable of automatically detecting one of inactivity, a walking activity and a running activity.

The activity detection application can be capable of identifying a type of activity based upon the selected activity, such as a duration activity, intensity activity or step activity. Thereafter, the activity detection application can determine at least one value based upon the type of activity. For example, the activity detection application can be capable of determining an activity type intensity value based upon the intensity value and an identified type of activity. Additionally or alternatively, the activity detection application can be capable of determining an activity-specific intensity value based upon the activity type intensity value and the selected activity.

Further, for example, when the activity is a duration activity, the activity detection application can be capable of determining an energy expended by the user in performing the selected activity based upon the selected activity and a duration over which the user performs the selected activity. Alternatively, when the activity comprises an intensity activity, the activity detection application can be capable of determining the energy expended by the user in performing the selected activity further based upon an intensity with which the user performs the selected activity. And when the activity comprises a step activity, the activity detection application can be capable of determining the energy expended by the user in performing the selected activity further based upon a speed of the user in performing the selected activity when the activity comprises a step activity.

The terminal can further include a display, which is capable of being driven by the activity detection application to present at least one value and at least one predefined goal associated with the presented value(s). In this regard, the activity detection application can be further capable of comparing the value(s) to at least one predefined goal associated with the value(s). In such instances, the goal(s) can reflect at least one value associated with at least one other user, and/or at least one reference value.

The activity detection application can be capable of driving the display to present the predefined goal(s) and a progress of the user toward the respective predefined goal(s), where the progress is based upon the value(s). More particularly, the activity detection application can be capable of driving the display to present a graphical representation of predefined goal(s), the graphical representation of the goal(s) including a plurality of sections, each section representing a successive percentage of the goal. In such instances, the activity detection application can also drive the display to present a graphical representation of the progress by altering a respective section of the graphical representation of the goal in response to the user meeting the successive percentage.

According to other aspects of the present invention, a method and computer program product are provided for monitoring at least one activity of a user. Therefore, embodiments of the present invention provide a terminal and associated method and computer program product for monitoring activit(ies) of a user. As indicated above and explained below, the terminal, method and computer program product of embodiments of the present invention are capable of monitoring the fitness activities of a user, and enabling the user to manage his or her personal fitness goals. The terminal, method and computer program product can be capable of recognizing movements representative of those of the terminal user in performing one or more activities. Based upon the movements, the terminal is capable of tracking information regarding the activit(ies) performed by the user. In accordance with embodiments of the present invention, the terminal can track information regarding the activit(ies) performed by the user based upon a selection of those activit(ies) to thereby permit the terminal to more particularly determine values such as the calorie consumption of the user. Information such as the calorie consumption of the user can then be used, such as to monitor the information of the user relative to personal fitness goals. Therefore, the system and associated terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a terminal of one embodiment of the present invention;

FIGS. 2A-2E are schematic illustrations of a terminal placed in proximity to a user, in accordance with various embodiments of the present invention;

FIG. 3 is a flowchart illustrating various steps in a method of monitoring at least one activity of a user, in accordance with one embodiment of the present invention;

FIGS. 4A-4D are schematic illustrations of a graphical representation of a goal of the user where each of a number of sections of the graphical representation represents a successive percentage of the goal and can be altered to reflect the user achieving the respective percentage;

FIG. 5 is a schematic bar graph illustrating values collected by the terminal over a number of successive time periods;

FIGS. 6A-6C, 7, 8A-8D, 9A-9D, 19, 11, 12A-12D, 13 and 14 are schematic illustrations of the terminal of embodiments of the present invention and various exemplar displays presented during operation of the terminal; and

FIG. 15 is a schematic block diagram of a wireless communications system according to one embodiment of the present invention including a mobile network and a data network to which a terminal is bi-directionally coupled through wireless RF links;

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

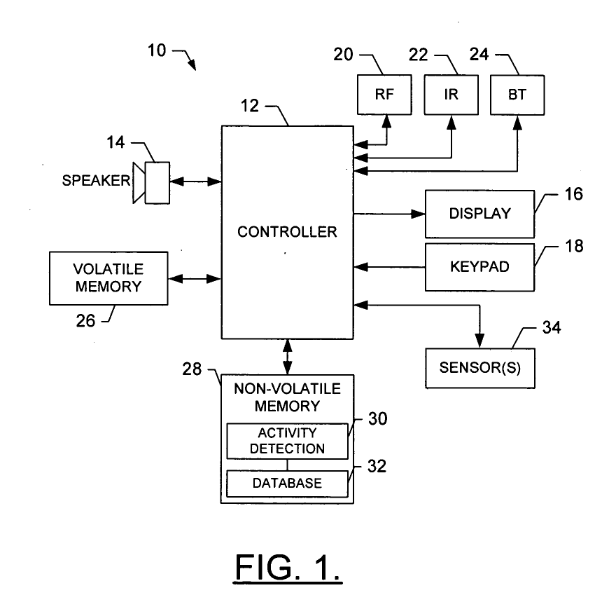

FIG. 1 illustrates a schematic block diagram of a terminal 10 in accordance with one embodiment of the present invention. It should be understood, that the terminal illustrated and hereinafter described is merely illustrative of one type of terminal that would benefit from the present invention and, therefore, should not be taken to limit the scope of the present invention. While several embodiments of the terminal are illustrated and will be hereinafter described for purposes of example, other types of terminals, such as mobile telephones, portable digital assistants (PDAs), pagers, and other types of voice and text communications systems, can readily employ the present invention.

As shown, the terminal 10 includes a processor such as a controller 12. The controller includes the circuitry required for implementing the functions of the terminal in accordance with embodiments of the present invention, as explained in greater detail below. For example, the controller may be comprised of a digital signal processor device, a microprocessor device, and/or various analog to digital converters, digital to analog converters, and other support circuits. The control and signal processing functions of the terminal are allocated between these devices according to their respective capabilities. The controller may also include the functionally to operate one or more software applications. In addition to the controller, the terminal also includes a user interface that may include, for example, a conventional earphone or speaker 14 capable of being driven by the controller to present various audible tones during operation of the terminal. The user interface may also include a display 16 and a user input interface, both of which are also coupled to the controller. The user input interface, which allows the terminal to receive data, can comprise any of a number of devices allowing the terminal to receive data, such as a keypad 18, a touch display (not shown) or other input device. In embodiments including a keypad, the keypad can include one or more keys used for operating the terminal.

The terminal can also include one or more means for sharing and/or obtaining data from electronic devices in accordance with any of a number of different wireline and/or wireless techniques, as also explained below. For example, the terminal can include a radio frequency (RF) transceiver 20 and/or an infrared (IR) transceiver 22 such that the terminal can share and/or obtain data in accordance with radio frequency and/or infrared techniques. Also, for example, the terminal can include a Bluetooth (BT) transceiver 24 such that the terminal can share and/or obtain data in accordance with Bluetooth transfer techniques. Although not shown, the terminal may additionally or alternatively be capable of transmitting and/or receiving data from electronic devices according to a number of different wireline and/or wireless networking techniques, including LAN and/or WLAN techniques.

The terminal 10 can further include memory, such as a volatile memory 26 and/or non-volatile memory 28. The non-volatile memory, for example, can comprise embedded or removable multimedia memory cards (MMC's), Memory Sticks manufactured by Sony Corporation, EEPROM, flash memory, hard disk or the like. The memories can store any of a number of pieces of information, and data, used by the terminal to implement the functions of the terminal. For example, the memories can store activity detection application 30 capable of operating on the terminal to monitor the fitness activities of a user of the terminal, and manage the user's personal fitness goals. In this regard, the memories can also store a database 32 including, for example, personal information regarding a user of the terminal, such as date of birth, gender, height and/or weight, as well as a step length for the user when walking and/or running. In addition, for example, the database can include personal fitness goals of the user, such as a one-time and/or weekly goal for an amount of time performing one or more activities, a number of steps take in performing the activit(ies), a number of calories burned in performing the activit(ies), and/or a distance traveled in performing the activit(ies). Likewise, for example, the database can include an amount of time spent by the user in performing one or more activities for a given time period, a number of steps taken in performing the activit(ies), a number of calories burned in performing the activit(ies), and/or a distance traveled in performing the activit(ies).

The terminal may also have one or more sensors 34 for sensing the ambient conditions of the terminal, where the conditions may be representative of the ambient conditions of the user of the terminal. In this regard, the terminal may include sensors such as, for example, a positioning sensor, a touch sensor, an audio sensor, a compass sensor, an ambient light sensor, and/or an ambient temperature sensor. The positioning sensor can comprise, for example, a global positioning system (GPS) sensor. Additionally, or alternatively, the positioning sensor can comprise, for example, a radio beacon triangulation sensor that determines the location of the wireless device by means of a network of radio beacons, base stations, or access points, as is described for example, in Nokia European patent EP 0 767 594 A3, entitled: Terminal Positioning System, published on May 12, 1999, the contents of which are hereby incorporated by reference in its entirety. Although the terminal can include any of a number of different sensors, in one typical embodiment, at least one of the sensors comprises a two or three-axis acceleration sensor (accelerometer).

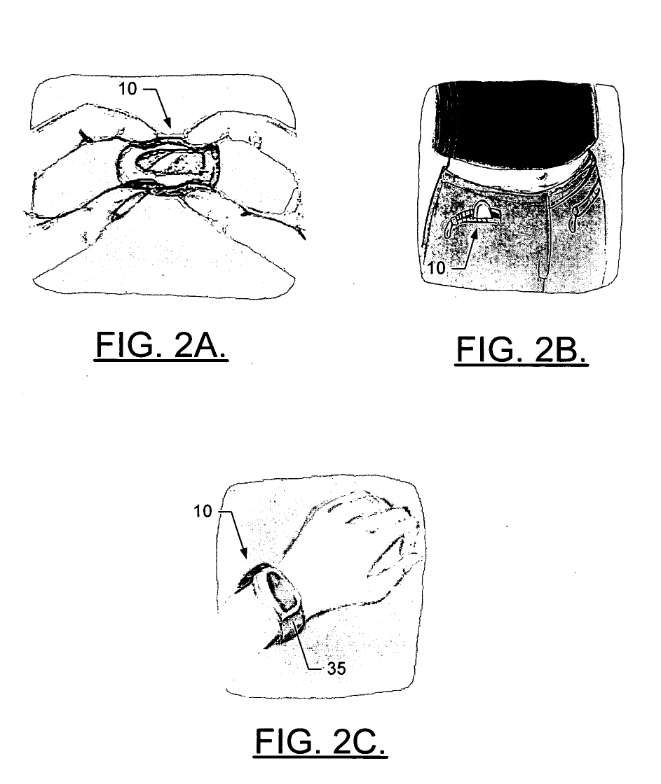

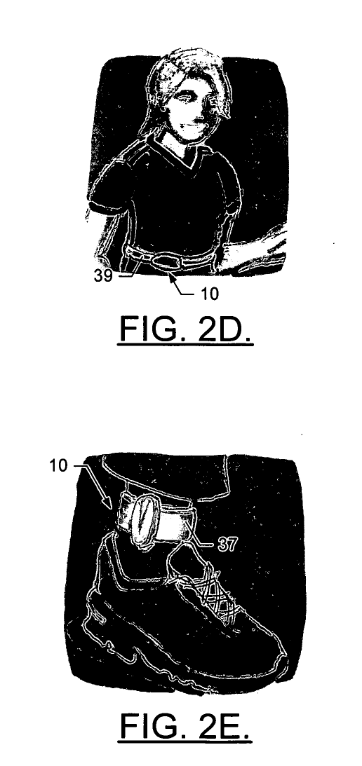

As indicated above, and shown in FIG. 2A, the terminal 10 of embodiments of the present invention is capable of being embodied in a portable package. The terminal can therefore be placed in relatively close proximity to the user. As shown in FIG. 2B, for example, the terminal can be carried in a pocket of clothing of the user. Alternatively, the terminal can be belted or otherwise strapped to a wrist, waist or ankle of the user, as shown in FIGS. 2C, 2D and 2E, respectively. In yet a number of other alternatives, for example, the terminal can be belted or otherwise strapped to an arm or leg of the user, hung from the user's neck, or clipped to clothing of the user. As will be appreciated, in many instances of placing the terminal in close proximity to the user, the terminal additionally includes a strap, belt, clip, lanyard or the like. For example, as shown in FIGS. 2C and 2E, when the terminal is strapped to the wrist or ankle of the user, the terminal can be embodied in a portable package that includes a wrist strap 35 or an ankle strap 37, both of which can comprise the same strap. Also, for example, as shown in FIG. 2D, when the terminal is belted around the waist of the user, the terminal can be embodied in a portable package that includes a belt 39.

Operation of the activity detection application 30 will now be described in accordance with embodiments of the present invention. In this regard, as indicated above, the activity detection application can be embodied in software stored in non-volatile memory 28 and operated by the controller 12 of the terminal 10. It should be understood, however, that whereas the activity detection application is typically embodied in software, the activity detection application can alternatively be embodied in firmware, hardware or the like. Generally, and as explained in greater detail below, the activity detection application is capable of interfacing with the sensor(s) 34 of the terminal to receive measurement(s) of the ambient condition(s) of the user, such as to receive acceleration measurements indicative of movement over a distance for one or more periods of time. In this regard, the movement may be representative of the user taking one or more steps while performing one or more activities over those period(s) of time. As the activity detection application receives such measurement(s), the activity detection application can be capable of tracking a duration of activity of the user, the distance moved by the user in performing the activity, the number of steps taken by the user of the distance, and/or the speed of movement of the user. The activity detection application can additionally be capable of computing energy (e.g., calories) expended by the user in performing the activity.

As will be appreciated, measurements received from the sensor(s) 34 may be indicative of the user running or walking while performing one or more of a number of different activities. For example, measurements may be indicative of the user performing activities such as walking, running, dancing, gardening (outdoor housework), performing housework (indoor housework), and/or participating in a sporting activity (e.g., aerobics, badminton, basketball, football, soccer, golf, weight training, hiking, jumping rope, squash, table tennis, tennis, Nordic training, squash, racquet ball, etc.). And as will also be appreciated, a user may expend more or less energy over a given duration, distance and number of steps depending upon the particular activity performed by the user. Thus, as the activity detection application receives measurement(s) of the ambient conditions of the user for each period of time, the activity detection application 30 can be capable of computing the energy expended by the user based upon the activity performed by the user and an intensity level with which the user performed the activity.

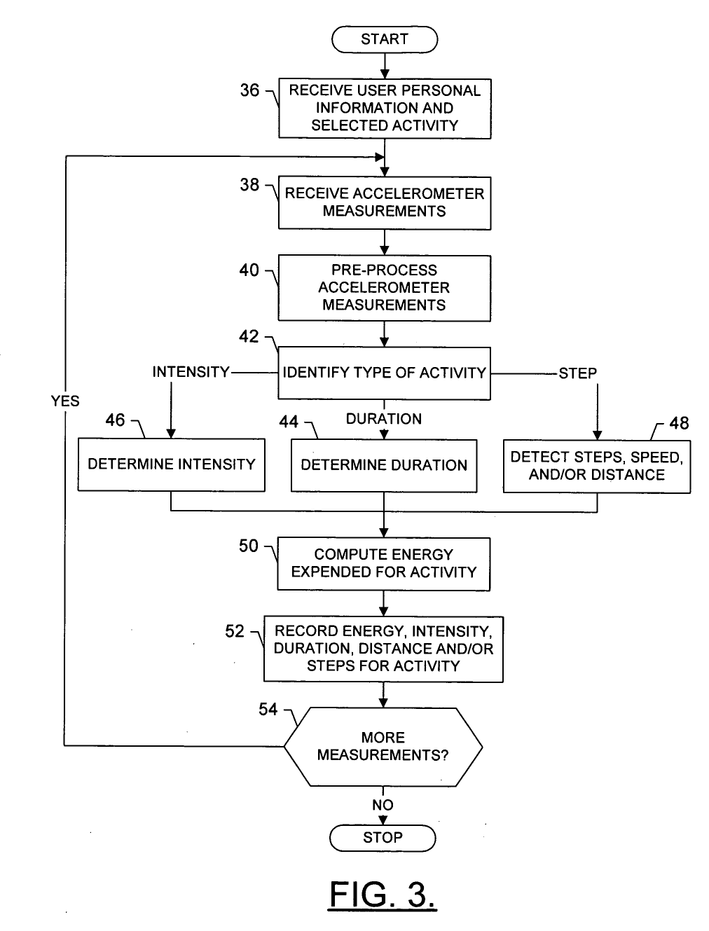

More particularly, reference is now to FIG. 3, which illustrates a method of monitoring at least one activity of a user, in accordance with one embodiment of the present invention. In operation, the activity detection application can be executed or otherwise initialized by the terminal 10, such as in response to user input via the user interface (e.g., keypad 18). Thereafter, as shown in FIG. 3, the activity detection application 30 can request, and thereafter receive, personal information from the user, as shown in block 36. The personal information can comprise any of a number of different pieces of information such as, for example, date of birth, gender, height and/or weight, as well as a step length for the user when walking and/or running. In addition to the personal information, the activity detection application can also request, and thereafter receive, selection of an activity the user is or will be performing during operation of the activity detection application. In this regard, the activity detection application may be capable of receiving a selection of any activity. In one typical embodiment, however, the activity detection application presents a list of activities, such as on the display 16 of the terminal, and thereafter receives a selection of one of the activities from the list. For example, the activity detection application can present a list of activities including walking, running, dancing, gardening (outdoor housework), performing housework (indoor housework), or participating in aerobics, badminton, basketball, football, soccer, golf, weight training, hiking, jumping rope, squash, table tennis, tennis, Nordic training, squash or racquet ball. And as explained below, the activity detection application can further present, and receive an “automatic detection” selection that, upon being selected, causes the activity detection application to detect an activity as the user performs the activity without further input from the user.

Irrespective of how the activity detection application 30 receives the user's personal information and selection of activity, the activity detection application can thereafter be operated to monitor the user in performing the selected activity. More particularly, the activity detection application can receive measurements from one or more sensors 34 of the terminal 10, where the sensor(s) are capable of measuring ambient conditions of the user of the terminal. In one typical embodiment shown in block 38 and described hereinbelow for purposes of illustration, the activity detection application receives acceleration measurements, such as down-acceleration (x-axis) and back-acceleration (y-axis) measurements, from an accelerometer. The activity detection application 30 can receive one or more measurements from the sensor(s) 34 at one or more different times during operation. In one embodiment, for example, the activity detection application receives measurements with a 25 Hz sampling frequency. If necessary, each sampled measurement can also be converted from an analog measurement into a digital measurement for subsequent processing by the activity detection application. For example, each sampled measurement can be passed through an analog-to-digital converter that converts the analog sample into a digital sample, such as a 12-bit digital sample representing measurement amplitudes from 0 to 4095.

Although the activity detection application 30 can receive measurements with a given sampling frequency, the activity detection application can be capable of dynamically adjusting the sampling frequency to thereby control power consumption of the terminal 10. For example, the activity detection application can receive measurements from the accelerometer, and if the measurements are below a given threshold, decrease the sampling frequency to thereby reduce power consumption of the terminal. The activity detection application can thereafter increase the sampling frequency if the measurements increase to above the threshold.

As the activity detection application 30 receives measurements from the accelerometer, the activity detection application can preprocess the accelerometer measurements for subsequent use by the activity detection application, as shown in block 40. For example, the activity detection application can limit the measurements to within a given range of measurements, and/or normalize the measurements. More particularly, for example, when the measurements are sampled and converted into 12-bit samples representing amplitudes from 0 to 4095, the activity detection application can limit each measurement, i, to within a range from 1700 to 2500 as follows:

$${\hat{x}}_{i} , {\hat{y}}_{i} = \{ \begin{matrix}1700 , & {x}_{i} , {y}_{i} < 1700 \\ {x}_{i} , {y}_{i} & 1700 < {x}_{i} , {y}_{i} < 2500 , \\ 2500 , & {x}_{i} , {y}_{i} > 2500\end{matrix}$$

where xᵢ and yᵢ refer to the ith down-acceleration (x-axis) and back-acceleration (y-axis) measurements from the accelerometer, respectively; and \hat{x}ᵢ and ŷᵢ refer to the ith range-limited down-acceleration (x-axis) and back-acceleration (y-axis) measurements, respectively. Generally, as used herein unless otherwise stated, xᵢ and yᵢ refer to measurements input into a processing step, and \hat{x}ᵢ and ŷᵢ refer to measurements output from the respective processing step.

Also, as indicated above, the activity detection application 30 can normalize the measurements. For example, the activity detection application can normalize the measurements about a base of zero by reducing each measurement by the average of all of the measurements. Written notationally, then, each measurement can be normalized as follows:

$${\hat{x}}_{i} , {\hat{y}}_{i} = {x}_{i} , {y}_{i} - \frac{1}{{N}_{1}} {\sum }_{k = i - {N}_{1}}^{i} {x}_{k} , {y}_{k} ,$$

where N₁ equals a number of samples in a sample window block (e.g., 128 samples) (where the mean computation in determining \hat{x}ᵢ and ŷᵢ can be performed once per sample window block); xᵢ and yᵢ refer to the ith measurements for the respective sample window block; and \hat{x}ᵢ and ŷᵢ normalized measurements for the respective sample window block.

Before or after pre-processing the measurements from the accelerometer, the activity detection application can identify a type of the selected activity, as shown in block 42. In this regard, as will be appreciated, different activities can include different dominating attributes defining the basis for computing the energy expended by the user in performing the respective activities. For example, the energy expended in performing activities such as gardening, weight training, housework and jumping rope can typically be determined based upon the duration over which the user performs the respective activities. For other activities such as dancing, aerobics, badminton, basketball, football, soccer, golf, hiking, squash, table tennis, tennis, Nordic training, squash and racquet ball, the energy expended by the user can typically be determined based upon an intensity with which the user performs the respective activities. Still yet, for activities such as walking and running, the energy expended by the user can be determined based upon the speed of the user in performing the respective activities.

The activity selected by the user (see block 36) can therefore have an associated type based upon the technique for computing the energy expended by the user in performing the selected activity. Although each activity can have any of a number of different types, in one typical embodiment, each activity can be identified as either a duration activity, an intensity activity or a step activity. In contrast to the intensity and step activities, as indicated above, energy expended by the user in performing duration activities can be determined based upon the duration over which the user performs the respective activities. Thus, in general, and more particularly for the duration activities, the activity detection application 30 can be capable of tracking the duration over which the user performs the selected activity, as shown in block 44.

For each intensity activity, on the other hand, an intensity value can be determined for the user in performing the activity, as shown in block 46. The intensity value can be determined in any of a number of different manners. In one embodiment, for example, the intensity value can be determined based upon an average acceleration measurement. More particularly, the intensity value, I, can be determined as follows:

$$I = \frac{1}{{N}_{2}} {\sum }_{k = i - {N}_{2}}^{i} \vert {x}_{k} \vert + \vert {y}_{k} \vert ,$$

where N₂ equals a number of samples taken during a given measurement period, which can equal or be different from N₁ indicated above. After determining the intensity value, if so desired, the intensity value can be scaled, such as to within a range from 0 to 100.

In contrast to intensity activities, for each step activity, the activity detection application 30 can detect each step of the user in performing the respective activity, as shown in block 48. As the user performs the activity, then, the activity detection application can track the number of steps taken by the user, as well as the speed with which the user takes the steps. Although the activity detection application can detect each step in any of a number of different manners, in one embodiment, the activity detection application detects each step by first bandpass filtering the accelerometer measurements. For example, the activity detection application can finite impulse response (FIR) filter the measurements, normalizing the filtered measurements to avoid overflow, if so desired.

As will be appreciated by those skilled in the art, the activity detection application can detect steps of the user based upon the down-acceleration (x-axis) measurements without the back-acceleration (y-axis) measurements. In various embodiments, however, it may be desirable to detect steps of the user based upon the back-acceleration measurements, particularly in instances when the user moves at a very low walking speed. The following description, therefore, will focus on the down-acceleration measurements, although it should be understood that the activity detection application can equally process the back-acceleration measurements in the same manner as the down-acceleration measurements, if so desired.

In one more particular embodiment, the activity detection application 30 can pass the down-acceleration measurements through the following FIR filter:

$${\hat{x}}_{i} = \frac{1}{{C}_{1}} {\sum }_{k = 0}^{m - 1} {h}_{k} {x}_{i - k} ,$$

where hₖ comprises each of m (e.g., m=16) filter taps, and C₁ comprises a constant (e.g., 2048). The FIR filter can include any of a number of different filter taps to realize the filter. For example, the FIR filter can include a set of filter taps for each step activity, such as one set of filter taps for walking activity and another set for running activity. In this regard, the filter taps for walking activity can realize a bandpass filter with cutoff frequencies at 0.1 and 4 Hz, while the filter taps for running activity can realize a bandpass filter with cutoff frequencies at 0.1 and 2 Hz.

After filtering the measurements, the activity detection application 30 can compute a threshold value from the filtered measurements. More particularly, for example, the activity detection application can determine a threshold, T, in accordance with the following:

$$T = \frac{{C}_{2}}{{N}_{1}} {\sum }_{k = i - {N}_{1}}^{i} \vert {x}_{k} \vert , {C}_{2} = \{ \begin{matrix}2 / 4 if walking \\ 3 / 4 if running\end{matrix} ,$$

where N₁, as before, equals a number of samples in a sample window block (e.g., 128 samples), where the mean computation in determining the threshold, T, can be performed once per sample window block. As will be appreciated, if so desired, the threshold can be configured to have a minimum value (e.g., T_{MIN}=25) to eliminate step detection from very low measurements, such as when the terminal 10 is resting on a desk.

After filtering measurements and computing the threshold value, then, the activity detection application 30 can detect steps by comparing the filtered measurements and the threshold value. More particularly, for example, the activity detection application can operate a state machine whereby S₀ represents the state when a measurement is greater than a respective threshold value, and S₁ represents the state when the measurement is less than the negative threshold value. From the states, then, the activity detection application can detect a step each time the state transitions from S₁ to S₀, i.e., each time the measurements that are less than the negative threshold value increase to being greater than the threshold value. Because the activity detection application can receive one or more sporadic measurements that can indicate a step when the user has not actually taken a step, if so desired, state S₁ can include a timeout (e.g., one second) such that if the measurements are not greater than the threshold within the timeout, state S₀ is entered without a corresponding step detection.

In addition to detecting each step, the activity detection application 30, as indicated above, can determine a speed at which the user performs the step activity, as also shown in block 48. For example, the activity detection application can determine a speed by determining the rate at which the activity detection application detects each step. The step rate can then be multiplied by the step length for the user when performing the respective step activity (e.g., walking, running, etc.), where the step length can be input by the user with other personal information (see block 36). Further, the activity detection application can determine the distance over which the user has performed the selected activity. For example, the activity detection application can determine distance by multiplying the number of detected steps by the step length for the respective activity.

As will be appreciated, the activity detection application 30 determines or computes a number of different values for each selected activity, whether an intensity activity, duration activity or step activity. It should be understood, however, that irrespective of the type of selected activity, the activity detection application can determine or compute the values for any one or more of the other activity types, without departing from the spirit and scope of the present invention. For example, irrespective of the activity type, the activity detection application can be capable of determining or computing any one or more of the intensity value, the duration of the activity, the number of detected steps, the speed at which the user performs the activity and/or the distance over which the user performs the activity.

More particularly, for example, the activity detection application 30 can determine or compute an intensity value representing the intensity with which the user performs an activity, regardless of the type of activity or particular selected activity, such as in a manner described above. As will be appreciated, however, the intensity value can be weighted based upon the type of activity and/or selected activity to reflect a relative effort required by the user in performing the type of activity and/or selected activity. In such instances, the intensity value determined as described above is considered a general intensity value. To weight the general intensity value, then, the general intensity value can be multiplied by a first weighting factor, W1, unique to the type of activity to thereby determine an activity type intensity value, such as in accordance with the following:
I_{duration, intensity, step}=I×W1_{duration, intensity, step}
For example, consider a general intensity value of 27, and a first weighting factor for a step activity of 2.33 (i.e., W1_{duration}=2.33). In such an instance, the activity detection application 30 can determine a duration intensity value, I_{duration}, equal to 63 (i.e., 27×2.33).

Then, if so desired, the activity type intensity value can be multiplied by a second weighting factor, W2, unique to a selected activity of the respective activity type to thereby determine an activity-specific intensity value, such as in accordance with the following:
I_{activity}=I_{duration, intensity, step}×W2_{activity}
Further, for example, consider a second weighting factor for walking of 1.5 (i.e., W2_{walking}=1.5). The activity detection application can then further determine a walking-specific intensity value, I_{walking}, equal to 94.5 (i.e., 63×1.5). As will be appreciated, the first weighting factors and second weighting factors, W1 and W2, can be determined in any of a number of different manners, such as from empirical analysis, studies or the like.

At one or more points in time, as or after the activity detection application 30 determines or computes one or more of the aforementioned values, the activity detection application can also compute the energy expended by the user in performing the selected activity, as shown in block 50. In this regard, as indicated above, the activity detection application can compute the energy expended based upon the activity, and further based upon the type of activity. In addition, the activity detection application can determine the energy expended by the user in performing a duration activity further based upon a basal metabolic rate (BMR) of the user, a metabolic equivalent (MET) and the duration over which the user performed the activity. Although the activity detection application can be configured to determine the energy expended by the user further based upon the user's nutritional intake, the activity detection application typically just determines the energy expended by the user in performing the selected activity, without regard to the user's nutritional intake.

More particularly, the activity detection application can determine the MET based upon the activity, and further based upon the intensity value when the selected activity has an intensity activity type, and further based upon the speed when the selected activity has a step activity type. Written notationally, then, the activity detection application can determine the number of calories expended by the user in accordance with one of the following:
Calories_{duration}=BMR×MET(activity)×time
Calories_{intensity}=BMR×MET(activity, intensity)×time
Caloriesₛₜₑₚ=BMR×MET(activity, speed)×time
The BMR and MET can be determined in any of a number of different manners. For example, the BMR can be determined based upon the gender, age and weight of the user, each of which can be input with other personal information of the user (see block 36). More particularly, the BMR can be determined from World Health Organization equations predicting the BMR based upon the age and weight of the user. For example, for males ages 18-30, the BMR can be determined as follows:
BMR₁₈₋₃₀=15.3×weight+679
where weight can be expressed in kilograms.

Like the BMR, the MET can be determined in any of a number of different manners. As will be appreciated MET values are typically defined as the energy cost of an activity, and comprise multiples of the BMR for different activities. The MET values for duration activities, for example, can comprise constant multipliers based upon the respective activity, where the constant can be determined from empirical analysis, studies or the like. For intensity activities, the MET can be determined based upon a relationship between the energy cost and intensity value for the selected activity. Thus, from empirical analysis, studies or the like, a relationship can be determined between MET and intensity, I, for each selectable activity. Although any order relationship can be determined between MET and intensity, I, in one embodiment a linear relationship can be determined that has the following form:
MET(activity, intensity)=C₃×I+C₄
In the preceding equation, C₃ and C₄ represent constants for the selected activity that define the linear relationship, both of which, as indicated above, can be determined from empirical analysis, studies or the like. As will be appreciated, in various instances it may be desirable to bound the relationship between MET and I to within minimum and maximum values, i.e., MET_{MAX}, MET_{MIN} and I_{MAX}, I_{MIN}. In such instances, when the intensity, I, is below I_{MIN}, C₃ and C₄ can be set equal to zero. And when I exceeds I_{MAX}, C₃ can be set equal to zero, while C₄ is set equal to MET_{MAX}.

In contrast to the MET for intensity activities, the MET for step activities can be determined by weighting the speed of performing the selected activity based upon the selected activity. More particularly, for example, the MET for step activities can be determined as follows:
MET(activity, speed)_{walking}=0.4930×speed
MET(activity, speed)_{running}=1.0×speed
where speed can be expressed in kilometers per hour (km/h).

As the activity detection application 30 operates and determines or computes the various values, the activity detection application can record one or more values, such as in the database 32 of the terminal 10. For example, as shown in block 52, the activity detection application can record the energy expended, duration, distance and/or detected steps for the user in performing the selected activity. As shown in block 54, during operation, the activity detection application can continuously receive measurements from the accelerometer, and determine or compute different values for the user in performing the selected activity.

The values recorded by the activity detection application 30 can thereafter be compared to previous values recorded by the activity detection application, and/or goals of the user. For example, the recorded energy expended, duration, distance and/or detected steps can be compared to previously recorded values and/or goals for energy expended, duration, distance and/or detected steps, respectively. As will be appreciated, the previously recorded values and/or goals can be compared for any of a number of different time periods, such as for a single activity, or one or more activities performed over a day, week, month, year, etc. By comparing the values required by the activity detection to previous values recorded by the activity detection application, the activity detection application can facilitate the user in reaching those goals, and/or in improving the user's technique in performing a given activity. For example, by comparing the intensity value over multiple time periods for the same activity performed over the same distance, the activity detection application can facilitate the user in improving the user's technique in performing the activity by decreasing the intensity value in performing the activity.

To permit the activity detection application 30 to compare the recorded values to goals of the user, either as or after the user inputs, and the activity detection application receives, personal information of the user, the user can input, and the activity detection application can receive, goals of the user relating to one or more selected activities. For example, the activity detection application can receive goals such as a desired amount of energy expended, duration of performing an activity, distance over which to perform the activity and/or number of steps in performing the activity. The goals can reflect any of a number of different goals of the user. For example, the goals can reflect personal goals of the user that can be determined based upon previous performance of the user. Additionally or alternatively, for example, one or more of the goals can reflect values associated with one or more other users. In such instances, for example, the values associated with the other user(s) can be received from other terminals 10, such as in accordance with any of a number of different techniques, as explained below. Additionally or alternatively, one or more of the goals can reflect reference values associated with sports figures or other personalities such as David Beckham (soccer), Jahangir Kahn (squash) or the like.

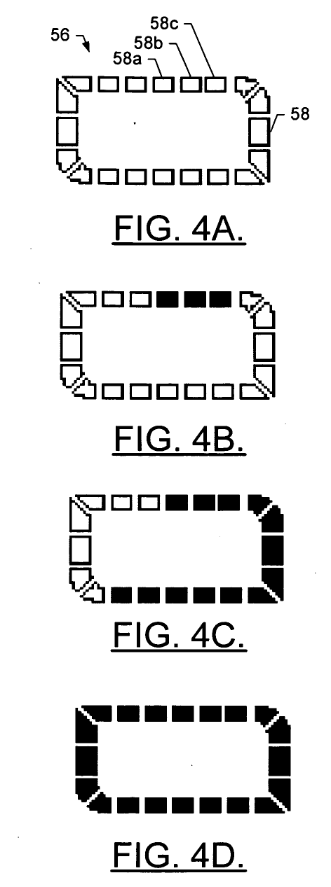

In addition to the values recorded over a given time period, and/or the goals for the respective values of the given time period, the activity detection application 30 can be capable of presenting the comparison of the goals of the user and the user's progress toward those goals. For example, as shown in FIGS. 4A-4D, the activity detection application can drive the display 16 to present a graphical representation of a goal of the user, such as in the form of a closed loop 56. As shown, the closed loop includes, or is broken into, a plurality of sections 58, where each section represents a successive percentage of the goal. In this regard, starting from one of the sections, each successive adjacent block in a given direction from the starting section 58a can represent a successive percentage of the goal. For example, for a goal of 2,000 calories represented by a closed loop including 20 sections, each section can represent 5% of the goal, or 100 calories. In this regard, starting section can represent the first 5%, with the section 58b to the immediate right of the starting section representing the second 5% (i.e., 10%) of the goal, the section 58c to the immediate right of section 58b representing the third 5% (i.e., 15%), and so forth.

As the activity detection application 30 identifies when user meets each successive percentage of a goal, such as by comparing the goal to the respective recorded values, the activity detection application can drive the display 16 to alter the respective section of the closed loop representation of the goal in response to the user meeting the successive percentage. The activity detection application can alter the respective section in any of a number of different manners. In one embodiment shown in FIGS. 4B-4C, for example, the activity detection application drives the display to change the color of the respective section, such as by changing the color from white, open or otherwise colorless to black, in response to the user meeting the successive percentage of the goal.

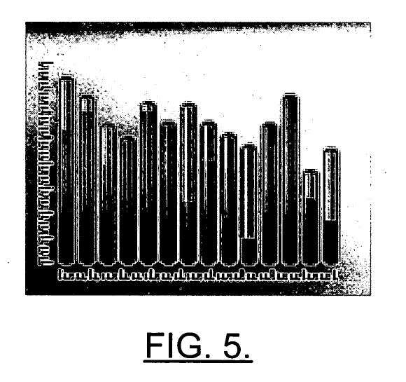

In addition to presenting a graphical representation of the goal and the user's progression toward a goal for a given time period, the time period can be increased or decreased for different time periods and the user's progression presented relative to those time periods. For example, a user's daily goal to walk 10,000 steps can be converted to a weekly goal by multiplying the daily goal by seven days per week (i.e., 70,000 steps), a monthly goal by multiply the daily goal by thirty days per month (i.e., 300,000 steps), and so forth. Alternatively, for example, a user's daily goal to walk 10,000 steps can be converted to an hourly goal by dividing the daily goal by twenty-four hours per day (i.e., 417 steps), a minute goal by dividing the daily goal by 1440 minutes per day (i.e., 7 steps), and so forth. The values relating to the respective goal can then be recorded and collected over the respective time period(s) and presented in relation to the respective goal(s), such as in a manner shown in FIGS. 4A-4D. Additionally or alternatively, the values relating to the respective goal can be pre presented in one or more other manners. For example, as shown in FIG. 5, the values can be presented in a bar graph of values over a number of successive time periods.

As indicated above, the activity detection application 30 can present, and receive an “automatic detection” selection that, upon being selected, causes the activity detection application to detect an activity as the user performs the activity. In one typical embodiment, for example, when the selected activity comprises “automatic detection,” the activity detection application can detect an activity from the user being inactive, or performing a walking or running activity. In this regard, over a sample window block (e.g., N=50), the mean absolute values for the down-acceleration (x-axis) and back-acceleration (y-axis) measurements can be computed, such as in accordance with the following:

$${x}_{mean} , {y}_{mean} = \frac{1}{N} {\sum }_{k = i - N}^{i} \vert {x}_{k} , {y}_{k} \vert$$

Then, for each pair [xₘₑₐₙ, yₘₑₐₙ], the activity detection application can determine the squared Euclidian distance, d, to a predefined centroid associated with each of the detectable activities. In this regard, each activity can have an associated coordinate pair of centroid values. The walking activity, for example, can have the following centroid coordinate pair: Cₓ=120, C_{y}=70. Written notationally, then, for each detectable activity, the distance d can be determined as follows:
d=(xₘₑₐₙ−Cₓ)²+(yₘₑₐₙ−C_{y})²
After determining the distance d to the centroid associated with each of the detectable activities, the activity detection application can select the activity having the shortest distance as the detected activity.

As will be appreciated, in various instances, the terminal 10 may be operating (having executed or otherwise initiated the activity detection application 30) at locations other than those proximate to a user performing a selected or detected activity, such as when the terminal is positioned at a storage location. The activity detection application can therefore be configured to determine, from measurements received from the accelerometer, the position of the terminal to thereby facilitate the activity detection application in identifying when the user is performing an activity, and when the terminal is operating during periods of inactivity of the user. From such a determination, then, the activity detection application can further compute the duration of time the user is actually inactive when the terminal is operating.

As indicated above, the terminal 10 can include one or more of the sensors 34 comprising a two or three-axis acceleration sensor (accelerometer). In instances in which the terminal includes a three-axis accelerometer, the activity detection application 30 can further receive measurements from all three axes to thereby determine a posture of the terminal when the terminal is operating. By determining the posture, the activity detection application can determine when the terminal is operating during periods of inactivity of the user independent of the orientation of the terminal. Further, the activity detection application can determine the posture of the user when an attachment position of the terminal to the user is known, such as to also permit the activity detection application can determine when the terminal is operating during periods of inactivity.

As indicated above, the activity detection application 30 can be capable of managing the user's personal fitness goals. In this regard, as also indicated above, the activity detection application can drive the display to present those goals, as well as the user's progression toward such goals. It should be understood, however, that the activity detection application can also dynamically adjust one or more goals of the user based upon the user's progression toward those goals. For example, presume that a user has a weekly goal of walking 70,000 steps that can be subdivided into a daily goal of 10,000 steps. Also, presume that over the first five days of the week the user has only walked a total of 10,000. In such instances, the activity detection application can adjust the daily goal of the user over the remaining two days of the week to 30,000 steps per day. By adjusting the daily goal to 30,000 steps per day, the user can meet the weekly goal of 70,000 steps by meeting the adjusted daily goal over the remaining two days of the week.

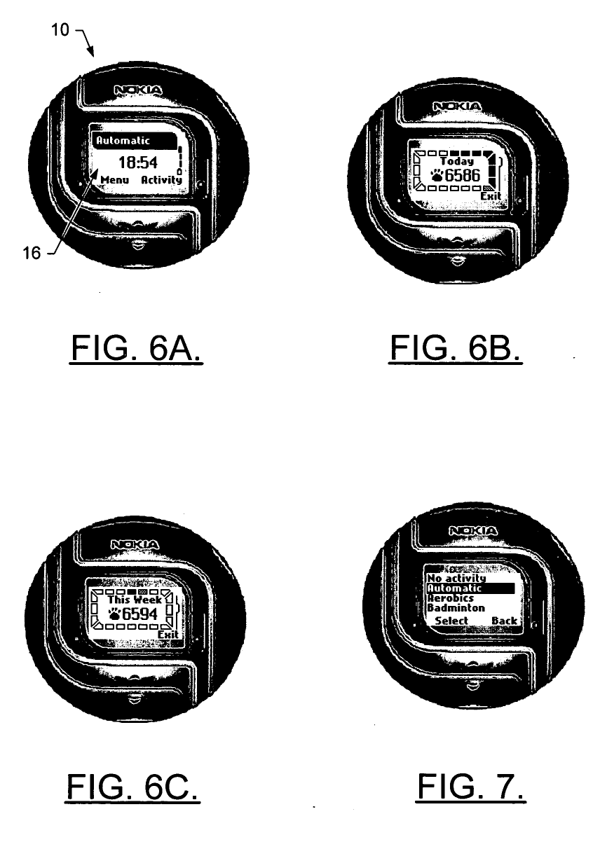

Reference is now made to FIGS. 6A-6C, 7, 8A-8D, 9A-9D, 10, 11, 12A-12D, 13 and 14, which illustrate the terminal 10 of embodiments of the present invention and various exemplar displays presented during operation of the terminal. As shown in FIG. 6A, upon activation of the activity detection application 30, the activity detection application can drive the display 16 to present a portal that indicates a current selected activity (e.g., “Automatic”), as well as the time (e.g., “18:54”) and soft keys capable of being selected to activate menu and activity selection functions. From the portal, the user can scroll through a number of different displays, including a display presenting a graphical representation of the user's progression toward a daily goal (FIG. 6B) and/or a weekly goal (FIG. 6C), such as in the same manner as described above with respect to FIGS. 4A-4D. As shown in FIGS. 6B and 6C, in addition to presenting the user's progression, the display can present the current value for the respective computation over the given time frame, such as the current step count (indicated by a footprint) for the current day (e.g., 6586 as in FIG. 6B) and/or the current week (e.g., 6594 as in FIG. 6C).

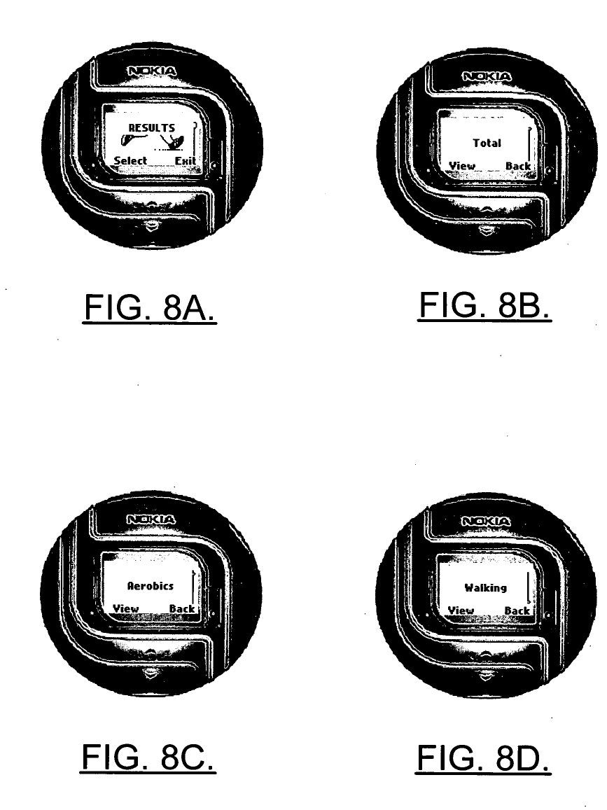

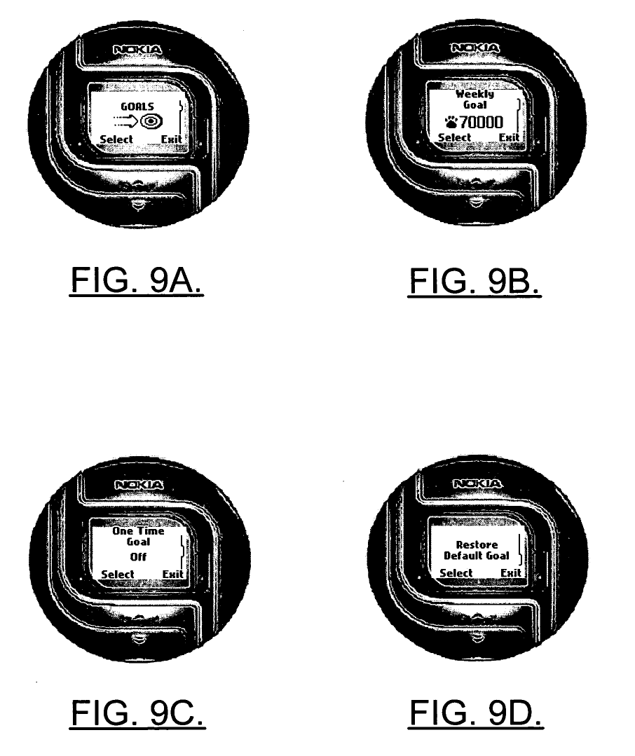

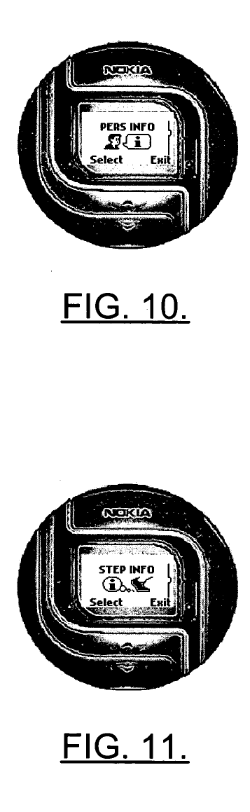

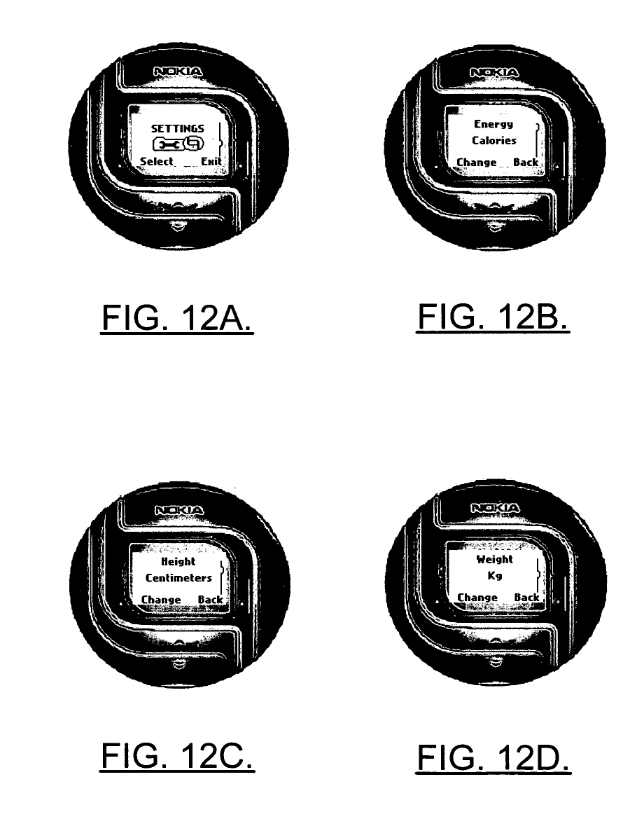

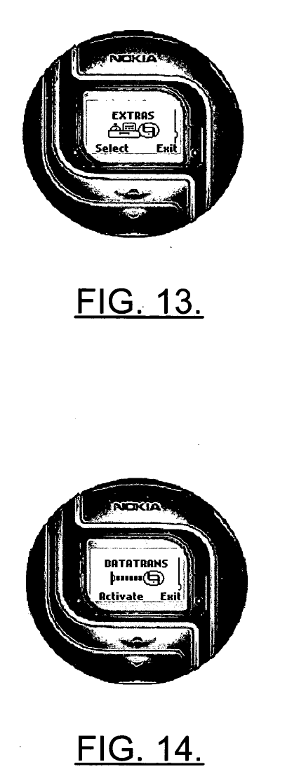

Also during operation, the user can be capable of selecting one of the soft keys presented by the display 16 (e.g., “Menu” and “Activity”), such as via the user input interface. As shown in FIG. 7, for example, upon selecting the “Activity” soft key, the user can be presented with a list of activities, such that the activity detection application 30 can thereafter receive a selection of one of the activities from the list (the currently selected activity being presented by the portal (see FIG. 6A). Upon selecting the “Menu” soft key, on the other hand, the user can be presented with a number of menu functions, including a “Results” function (FIGS. 8A-8D), a “Goals” function (FIGS. 9A-9D), a “Personal Information” function (FIG. 10), a “Step Information” function (FIG. 11), a “Settings” function (FIGS. 12A-12D), an “Extras” function (FIG. 13), and/or a “Data Transmission” function (FIG. 14).

As shown more particularly in FIGS. 8A-8D, for example, upon selecting the “Results” function, the activity detection application 30 can drive the display 16 to present the total energy expended by the user in performing all selected activities over one or more time periods (FIG. 8B), and/or the energy expended by the user in performing individual selected activities over one or more time periods (aerobics shown in FIG. 8C and walking shown in FIG. 8D).

As shown in FIGS. 9A-9D, for example, upon selecting the “Goals” function, the activity detection application 30 can drive the display 16 to present the current weekly goal (e.g., 70000 steps, as shown in FIG. 9B). From the display of the current weekly goal, then, the user can be capable of selecting and modifying the goal, such as by modifying the value of the goal or the type of goal (e.g., energy expended, duration, steps, distance, etc.). In addition to presenting the weekly goal, the “Goals” function can also permit the user to set a one-time goal, such as for energy expended, duration, steps, distance, etc. And as will be appreciated, in lieu of setting a personal goal, the user can elect to set one or more goals based upon default settings that can be pre-stored within the terminal 10, as shown in FIG. 9D. For example, the terminal 10 can store, and the user can elect, one or more predefined goals, such as to maintain the user in good health.

As shown briefly in FIG. 10, upon selecting the “Personal Information” function, the activity detection application 30 can drive the display 16 to request, and thereafter receive from the user, personal information such as date of birth, gender, height and/or weight. For additional personal information, the user can select the “Step Information” function, as shown briefly in FIG. 11. Upon selection of the “Step Information” function, the activity detection application can drive the display to request, and thereafter receive from the user, a step length for the user when walking and/or running.

It should be noted that many of the values measured, determined and/or computed in accordance with embodiments of the present invention have associated units. In this regard, upon selecting the “Settings” function, as shown in FIGS. 12A-12D, the user can be capable of choosing the units to associate with one or more values. For example, as shown in FIG. 12B, the user can be capable of selecting the units to associate with energy expended by the user (e.g., “Calories”). As shown in FIG. 12C, the user can be capable of selecting the units to associate with the user's height (e.g., “Centimeters”); and as shown in FIG. 12D, the user can be capable of selecting the units to associate with the weight of the user (e.g., “kilograms”).

As shown briefly in FIG. 13, upon selecting the “Extras” function, the activity detection application 30 can drive the display 16 to request, and thereafter receive from the user, a selection of one or more extra functions of the terminal 10. In this regard, in addition to operating the activity detection application 30, the terminal can be capable of performing one or more additional, or extra, functions. For example, the terminal can be include, and be capable of operating, a global positioning system (GPS), a radio, a clock, a digital music (e.g., MP3) player, portable digital assistant (PDA), organizer, mobile telephone or the like.

Further, as shown briefly in FIG. 14, upon selecting the “Data Transmission” function, the activity detection application 30 can communicate with one or more one or more means for sharing and/or obtaining data from electronic devices, such as a RF transceiver 20, IR transceiver 22, Bluetooth transceiver 24 or the like (see FIG. 1), to thereby transmit and/or receive data. In this regard, the terminal 10 can be capable of communicating with a mobile station, terminal or the like, such as that disclosed by Great Britain (GB) Patent Application No. 0326387.8, entitled: Apparatus and Method for Providing a User with a Personal Exercise Program, filed Nov. 12, 2003, the contents of which are hereby incorporated by reference in its entirety. In communicating with a mobile station such as that disclosed by GB 0326387.8, the terminal of embodiments of the present invention can be capable of sending data to the mobile station, such as values computed during operation of the activity detection application 30 (e.g., energy expended, duration, steps, distance, etc.), for subsequent use by the mobile station. Additionally, or alternatively, the terminal of embodiments of the present invention can be capable of receiving data from the mobile station, such as goal settings, and/or BMR, MET, other activity-dependent values or the like.

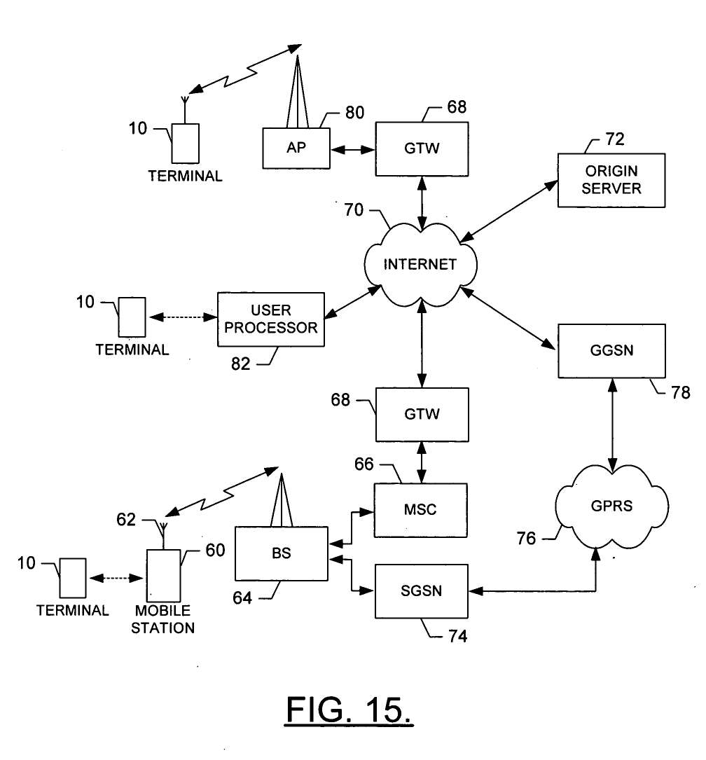

Referring to FIG. 15, an illustration of one type of system that would benefit from the terminal 10 of embodiments of the present invention is provided. The system will be primarily described in conjunction with mobile communications applications. It should be understood, however, that the system can be utilized in conjunction with a variety of other applications, both in the mobile communications industries and outside of the mobile communications industries. For example, the system of embodiments of the present invention can be utilized in conjunction with wireline and/or wireless network (e.g., Internet) applications.

As shown, the terminal 10 is capable of interfacing with a mobile station 60, such as the mobile station disclose by GB 0326387.8, in accordance with techniques such as, for example, radio frequency (RF), Bluetooth (BT), infrared (IrDA) or any of a number of different wireless networking techniques, including WLAN techniques. It should be understood, however, that although the terminal and mobile station are shown and described herein as comprising separate components of the system of FIG. 15, one or more entities may support both the terminal and the mobile station, logically separated but co-located within the entit(ies), without departing from the spirit and scope of the present invention. The mobile station 10 may include an antenna 62 for transmitting signals to and for receiving signals from a base site or base station (BS) 64. The base station is a part of one or more cellular or mobile networks that each include elements required to operate the network, such as a mobile switching center (MSC) 66.

As well known to those skilled in the art, the mobile network may also be referred to as a Base Station/MSC/Interworking function (BMI). In operation, the MSC is capable of routing calls to and from the mobile station when the mobile station is making and receiving calls. The MSC can also provide a connection to landline trunks when the mobile station is involved in a call. In addition, the MSC can be capable of controlling the forwarding of messages to and from the mobile station, and can also control the forwarding of messages for the mobile station to and from a messaging center, such as short messaging service (SMS) messages to and from a SMS center (SMSC).

The MSC 66 can be coupled to a data network, such as a local area network (LAN), a metropolitan area network (MAN), and/or a wide area network (WAN). The MSC can be directly coupled to the data network. In one typical embodiment, however, the MSC is coupled to a GTW 68, and the GTW is coupled to a WAN, such as the Internet 70. In turn, devices such as processing elements (e.g., personal computers, server computers or the like) can be coupled to the mobile station 60, and thus the terminal 10, via the Internet. For example, as explained below, the processing elements can include one or more processing elements associated with an origin server 72 or the like, one of which being illustrated in FIG. 15.

The BS 14 can also be coupled to a signaling GPRS (General Packet Radio Service) support node (SGSN) 74. As is well known, the SGSN is typically capable of performing functions similar to the MSC 66 for packet switched services. The SGSN, like the MSC, can be coupled to a data network, such as the Internet 70. The SGSN can be directly coupled to the data network. In a more typical embodiment, however, the SGSN is coupled to a packet-switched core network, such as a GPRS core network 76. The packet-switched core network is then coupled to another GTW, such as a GTW GPRS support node (GGSN) 78, and the GGSN is coupled to the Internet. In addition to the GGSN, the packet-switched core network can also be coupled to a GTW 68. Also, the GGSN can be coupled to a messaging center, such as a multimedia messaging service (MMS) center. In this regard, the GGSN and the SGSN, like the MSC, can be capable of controlling the forwarding of messages, such as MMS messages. The GGSN and SGSN can also be capable of controlling the forwarding of messages for the mobile station, and thus the terminal 10, to and from the messaging center.

In addition, by coupling the SGSN 74 to the GPRS core network 76 and the GGSN 78, devices such as origin servers 72 can be coupled to the mobile station 60, and thus the terminal 10, via the Internet 80, SGSN and GGSN. In this regard, devices such as origin servers can communicate with the mobile station across the SGSN, GPRS and GGSN. For example, origin servers can provide content to the mobile station, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

Although not every element of every possible mobile network is shown and described herein, it should be appreciated that the mobile station 60, and thus the terminal 10, can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

In addition to, or in lieu of, interfacing the terminal with a mobile station 60, the terminal 10 can be coupled to one or more wireless access points (APs) 80. The APs can comprise access points configured to communicate with the terminal in accordance with techniques such as, for example, radio frequency (RF), Bluetooth (BT), infrared (IrDA) or any of a number of different wireless networking techniques, including WLAN techniques. Additionally, or alternatively, the terminal can be coupled to one or more user processors 82. Each user processor can comprise a computing system such as personal computers, laptop computers or the like. In this regard, the user processors can be configured to communicate with the mobile station in accordance with techniques such as, for example, RF, BT, IrDA or any of a number of different wireline or wireless communication techniques, including LAN and/or WLAN techniques. One or more of the user processors can additionally, or alternatively, include a removable memory capable of storing content, which can thereafter be transferred to the terminal.

The APs 80 and the user processors 82 may be coupled to the Internet 70. Like with the MSC 66, the APs and user processors can be directly coupled to the Internet. In one advantageous embodiment, however, the APs are indirectly coupled to the Internet via a GTW 68. As will be appreciated, by directly or indirectly connecting the terminals 10 and the origin server 72, as well as any of a number of other devices, to the Internet, the terminals can communicate with one another, the origin server, etc., to thereby carry out various functions of the terminal, such as to transmit data, content or the like to, and/or receive content, data or the like from, the origin server.

According to one aspect of the present invention, all or a portion of the system of the present invention, such as all or portions of the terminal 10 generally operates under control of a computer program product (e.g., activity detection application 30). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 3 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart supports combinations of means for performing the specified functions, combinations of steps for performing the specified functions and program instruction means for performing the specified functions. It will also be understood that each block or step of the flowchart, and combinations of block(s) or step(s) in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A terminal for monitoring at least one activity of a user, the terminal comprising:
a connecting means for attaching the terminal onto a body of the user;
at least one acceleration sensor capable of measuring and providing acceleration measurement signals representative of movement of the user in performing an activity; and
a controller capable of operating an activity detection application, wherein the activity detection application is capable of receiving at least a portion of the measurement signals, and wherein the activity detection application is capable of determining at least one value related to the user performing the activity based upon the acceleration measurement signals, the at least one value comprising an intensity value representing an intensity with which the user performs the activity.

2. A terminal according to claim 1, wherein the activity detection application is capable of further receiving a selection of an activity, and wherein the activity detection application is capable of determining the at least one value further based upon the selected activity.

3. A terminal according to claim 2, wherein the activity detection application is capable of receiving a selection of an activity automatically detectable by the activity detection application.

4. A terminal according to claim 3, wherein the activity detection application is also capable of automatically detecting an activity performed by the user before determining at least one value, wherein the activity detection application is capable of automatically detecting one of inactivity, a walking activity and a running activity.

5. A terminal according to claim 2, wherein the activity detection application is capable of identifying a type of activity based upon the selected activity, and thereafter determining at least one value based upon the type of activity.

6. A terminal according to claim 5, wherein the activity detection application is capable of determining an activity type intensity value based upon the intensity value and the identified type of activity.

7. A terminal according to claim 6, wherein the activity detection application is capable of determining an activity-specific intensity based upon the activity type intensity value and the selected activity.

8. A terminal according to claim 5, wherein the activity detection application is capable of identifying one of a duration activity, an intensity activity and a step activity.

9. A terminal according to claim 5, wherein the activity detection application is capable of determining at least one value comprising an energy expended by the user in performing the selected activity based upon the selected activity and a duration over which the user performs the selected activity when the activity comprises a duration activity.

10. A terminal according to claim 9, wherein the activity detection application is capable of determining the energy expended by the user in performing the selected activity further based upon the intensity value when the activity comprises an intensity activity.

11. A terminal according to claim 9, wherein the activity detection application is capable of determining the energy expended by the user in performing the selected activity further based upon a speed of the user in performing the selected activity when the activity comprises a step activity.

12. A terminal according to claim 1, wherein the activity detection application is capable of determining at least one value further comprising at least one of an energy expended by the user in performing the activity, a duration over which the user performs the activity, and a speed of the user in performing the activity.

13. A terminal according to claim 1, wherein the activity detection application is capable of determining at least one value comprising at least one of a number of steps taken by the user in performing the activity, and a distance over which the user performs the activity.

14. A terminal according to claim 1, wherein the activity detection application is also capable of determining a position of the terminal to thereby facilitate identifying when the terminal is operating during at least one period of inactivity of the user.

15. A terminal according to claim 1, wherein the activity detection application is also capable of determining a posture of the terminal to thereby determine when the terminal is operating during at least one period of inactivity of the user.

16. A terminal according to claim 1 further comprising:
a display, wherein the activity detection application is capable of driving the display to present at least one value and at least one predefined goal associated with the at least one value.

17. A terminal according to claim 16, wherein the activity detection application is capable of driving the display to present the at least one predefined goal and a progress of the user toward the respective at least one predefined goal, and wherein the progress is based upon the at least one value.

18. A terminal according to claim 17, wherein the activity detection application is capable of driving the display to present a graphical representation of at least one predefined goal, the graphical representation of the at least one goal including a plurality of sections, each section representing a successive percentage of the goal, and wherein the activity detection application is capable of driving the display to present a graphical representation of the progress by altering a respective section of the graphical representation of the goal in response to the user meeting the successive percentage.

19. A terminal according to claim 1, wherein the at least one acceleration sensor is capable of measuring and providing acceleration measurement signals with a given sampling frequency, and wherein the activity detection application is capable of dynamically adjusting the sampling frequency of the at least one acceleration sensor to thereby control power consumption of the terminal.

20. A terminal according to claim 1, wherein the activity detection application is further capable of comparing the at least one value to at least one predefined goal associated with the at least one value.

21. A terminal according to claim 20, wherein the at least one goal reflects at least one of at least one value associated with at least one other user, and at least one reference value.

22. A terminal for monitoring at least one activity of a user, the terminal comprising:
a display; and
a controller capable of driving the display to present a graphical representation of at least one quantitative goal of the user, wherein at least one quantitative goal is related to an intensity with which the user performs the activity, wherein the graphical representation including a plurality of sections, each section representing a successive percentage of the at least one goal, wherein the processor is capable of identifying when at least one value related to the at least one goal meets each successive percentage of the at least one goal and driving the display to alter a respective section of the graphical representation of the at least one goal in response to the user meeting the successive percentage, the at least one value comprising an intensity value representing an intensity with which the user performs the activity.

23. A terminal according to claim 22, wherein the controller is also capable of driving the display to present a numerical representation of the at least one value related to the at least one goal.

24. A terminal according to claim 22, wherein the controller is capable of driving the display to present a graphical representation of the at least one goal for a given time period, and wherein the controller is capable of altering the time period and accordingly driving the display to present a graphical representation of the at least one goal for the altered time period.

25. A terminal according to claim 22, wherein the controller is also capable of receiving a selection of an activity and acceleration measurement signals representative of movement of the user in performing an activity, and wherein the controller is capable of determining at least one value related to the at least one goal based upon the activity and the acceleration measurement signals.

26. A terminal according to claim 25, wherein the controller is capable of identifying a type of activity based upon the selected activity, and thereafter determining at least one value related to at least one goal based upon the type of activity.

27. A terminal according to claim 26, wherein the controller is capable of identifying one of a duration activity, an intensity activity and a step activity.

28. A terminal according to claim 26, wherein at least one quantitative goal is related to an energy expended by the user in performing the selected activity, and wherein the controller is capable of determining at least one value comprising the energy expended by the user in performing the selected activity based upon the selected activity and a duration over which the user performs the selected activity when the activity comprises a duration activity.

29. A terminal according to claim 28, wherein the activity detection application is capable of determining the energy expended by the user in performing the selected activity further based upon the intensity value when the activity comprises an intensity activity.

30. A terminal according to claim 28, wherein the activity detection application is capable of determining the energy expended by the user in performing the selected activity further based upon a speed of the user in performing the selected activity when the activity comprises a step activity.

31. A method of monitoring at least one activity of a user, the method performed by a terminal and comprising:
receiving acceleration measurement signals representative of movement of the user in performing an activity; and
determining at least one value related to the user performing the activity based upon the acceleration measurement signals, the at least one value comprising an intensity value representing an intensity with which the user performs the activity.

32. A method according to claim 31 further comprising:
receiving a selection of an activity,
wherein determining at least one value comprises determining at least one value related to the user performing the selected activity further based upon the activity.

33. A method according to claim 32, wherein receiving a selection of an activity comprises receiving a selection of an activity automatically detectable by the terminal.

34. A method according to claim 33 further comprising:
automatically detecting an activity performed by the user before determining at least one value, wherein automatically detecting an activity comprises automatically detecting one of inactivity, a walking activity and a running activity.

35. A method according to claim 32, wherein determining at least one value comprises identifying a type of activity based upon the selected activity, and thereafter determining at least one value based upon the type of activity.

36. A method according to claim 35 further comprising:
determining an activity type intensity value based upon the intensity value and the identified type of activity.

37. A method according to claim 36 further comprising:
determining an activity-specific intensity value based upon the activity type intensity value and the selected activity.

38. A method according to claim 35, wherein identifying a type of activity comprises identifying one of a duration activity, an intensity activity and a step activity.

39. A method according to claim 35, wherein determining at least one value comprises determining an energy expended by the user in performing the selected activity based upon the selected activity and a duration over which the user performs the selected activity when the activity comprises a duration activity.

40. A method according to claim 39, wherein determining at least one value comprises determining an energy expended by the user in performing the selected activity further based upon the intensity value when the activity comprises an intensity activity.

41. A method according to claim 39, wherein determining at least one value comprises determining an energy expended by the user in performing the selected activity further based upon a speed of the user in performing the selected activity when the activity comprises a step activity.

42. A method according to claim 31, wherein determining at least one value comprises further determining at least one of an energy expended by the user in performing the activity, a duration over which the user performs the activity, and a speed of the user in performing the activity.

43. A method according to claim 31, wherein determining at least one value comprises determining at least one of a number of steps taken by the user in performing the activity, and a distance over which the user performs the activity.

44. A method according to claim 31 further comprising:
determining a position of the terminal to thereby facilitate identifying when the terminal is operating during at least one period of inactivity of the user.

45. A method according to claim 31 further comprising:
determining a posture of the terminal to thereby determine when the terminal is operating during at least one period of inactivity of the user.

46. A method according to claim 31 further comprising:
presenting at least one value and at least one predefined goal associated with the at least one value.

47. A method according to claim 46, wherein presenting at least one value and at least one predefined goal comprises presenting the at least one predefined goal and a progress of the user toward the respective at least one predefined goal, and wherein the progress is based upon the at least one value.

48. A method according to claim 47, wherein presenting at least one predefined goal comprises presenting a graphical representation of at least one predefined goal, the graphical representation of the at least one goal including a plurality of sections, each section representing a successive percentage of the goal, and wherein presenting a progress of the user toward the respective at least one goal comprises presenting a graphical representation of the progress by altering a respective section of the graphical representation of the goal in response to the user meeting the successive percentage.

49. A method according to claim 31, wherein receiving acceleration measurement signals comprises receiving acceleration measurement signals with a given sampling frequency, and wherein the method further comprises:
dynamically adjusting the sampling frequency to thereby control power consumption of the terminal.

50. A method according to claim 34 further comprising:
comparing the at least one value to at least one predefined goal associated with the at least one value.

51. A method according to claim 50, wherein comparing the at least one value to at least one predefined goal comprises comparing the at least one value to at least one predefined goal reflecting at least one of at least one value associated with at least one other user, and at least one reference value.

52. A method of monitoring at least one activity of a user, the method performed by a terminal and comprising:
driving a display to present a graphical representation of at least one quantitative goal of the user, wherein the at least one quantitative goal is related to an intensity with which the user performs the activity, and wherein the graphical representation includes a plurality of sections, each section representing a successive percentage of the at least one goal;
identifying when at least one value related to the at least one goal meets each successive percentage of the at least one goal; and
driving the display to alter a respective section of the graphical representation of the at least one goal in response to the user meeting the successive percentage.

53. A method according to claim 52 further comprising:
driving the display to present a numerical representation of the at least one value related to the at least one goal.

54. A method according to claim 52, wherein driving a display to present a graphical representation of a quantitative goal comprises driving a display to present a graphical representation of a quantitative goal for a given time period, and wherein the method further comprises:
altering the time period and accordingly driving the display to present a graphical representation of the at least one goal for the altered time period.

55. A method according to claim 52 further comprising:
receiving a selection of an activity and acceleration measurement signals representative of movement of the user in performing an activity; and
determining at least one value related to the at least one goal based upon the activity and the acceleration measurement signals.

56. A method according to claim 55, wherein determining the at least one value comprises:
identifying a type of activity based upon the selected activity; and thereafter
determining at least one value related to the at least one goal based upon the type of activity.

57. A method according to claim 56, wherein identifying a type of activity comprises identifying one of a duration activity, an intensity activity and a step activity.

58. A method according to claim 56, wherein at least one quantitative goal is related to an energy expended by the user in performing the selected activity, and wherein determining the value comprises determining at least one value comprising the energy expended by the user in performing the selected activity based upon the selected activity and a duration over which the user performs the selected activity when the activity comprises a duration activity.

59. A method according to claim 58, wherein determining an energy expended by the user comprises determining the energy expended by the user in performing the selected activity further based upon the intensity value when the activity comprises an intensity activity.

60. A method according to claim 58, wherein determining an energy expended by the user comprises determining the energy expended by the user in performing the selected activity further based upon a speed of the user in performing the selected activity when the activity comprises a step activity.

61. A computer program product for monitoring at least one activity of a user, wherein the computer program product adapted to operate within a terminal, and wherein the computer program product comprises at least one computer-readable storage medium having computer-readable program code portions stored therein, the computer-readable program code portions comprising:
a first executable portion for receiving acceleration measurement signals representative of movement of the user in performing an activity; and
a second executable portion for determining at least one value related to the user performing the activity based upon the acceleration measurement signals, the at least one value comprising an intensity value representing an intensity with which the user performs the activity.

62. A computer program product according to claim 61 further comprising:
a third executable portion for receiving a selection of an activity,
wherein the second executable portion is adapted to determine at least one value related to the user performing the selected activity further based upon the activity.

63. A computer program product according to claim 62, wherein the third executable portion is adapted to receive a selection of an activity automatically detectable by the terminal.

64. A computer program product according to claim 63 further comprising:
a fourth executable portion for automatically detecting an activity performed by the user before determining at least one value, wherein the fourth executable portion is adapted to automatically detect one of inactivity, a walking activity and a running activity.

65. A computer program product according to claim 62, wherein the second executable portion is adapted to identify a type of activity based upon the selected activity, and thereafter determine at least one value based upon the type of activity.

66. A computer program product according to claim 65 further comprising:
a fourth executable portion for determining an activity type intensity value based upon the intensity value and the identified type of activity.

67. A computer program product according to claim 66 further comprising:
a fifth executable portion for determining an activity-specific intensity value based upon the activity type intensity value and the selected activity.

68. A computer program product according to claim 65, wherein the second executable portion is adapted to identify one of a duration activity, an intensity activity and a step activity.

69. A computer program product according to claim 65, wherein the second executable portion is adapted to determine an energy expended by the user in performing the selected activity based upon the selected activity and a duration over which the user performs the selected activity when the activity comprises a duration activity.

70. A computer program product according to claim 69, wherein the second executable portion is adapted to determine an energy expended by the user in performing the selected activity further based upon the intensity value when the activity comprises an intensity activity.

71. A computer program product according to claim 69, wherein the third executable portion is adapted to determine an energy expended by the user in performing the selected activity further based upon a speed of the user in performing the selected activity when the activity comprises a step activity.

72. A computer program product according to claim 61, wherein the second executable portion is adapted to determine at least one of an energy expended by the user in performing the activity, a duration over which the user performs the activity, and a speed of the user in performing the activity.

73. A computer program product according to claim 61, wherein the second executable portion is adapted to determine at least one of a number of steps taken by the user in performing the selected activity, and a distance over which the user performs the selected activity.

74. A computer program product according to claim 61 further comprising:
a third executable portion for determining a position of the terminal to thereby facilitate identifying when the terminal is operating during at least one period of inactivity of the user.

75. A computer program product according to claim 61 further comprising:
a third executable portion for determining a posture of the terminal to thereby determine when the terminal is operating during at least one period of inactivity of the user.

76. A computer program product according to claim 61 further comprising:
a third executable portion for driving a display to present at least one value and at least one predefined goal associated with the at least one value.

77. A computer program product according to claim 76, wherein the third executable portion is adapted to drive the display to present the at least one predefined goal and a progress of the user toward the respective at least one predefined goal, and wherein the progress is based upon the at least one value.

78. A computer program product according to claim 77, wherein the third executable portion is adapted to drive the display to present a graphical representation of at least one predefined goal, the graphical representation of the at least one goal including a plurality of sections, each section representing a successive percentage of the goal, and wherein the third executable portion is adapted to drive the display to present a graphical representation of the progress by altering a respective section of the graphical representation of the goal in response to the user meeting the successive percentage.

79. A computer program product according to claim 61, wherein the first executable portion is adapted to receive acceleration measurement signals with a given sampling frequency, and wherein the computer program product further comprises:
a third executable portion for dynamically adjusting the sampling frequency to thereby control power consumption of the terminal.

80. A computer program product claim 61 further comprising:
a third executable portion for comparing the at least one value to at least one predefined goal associated with the at least one value.

81. A method according to claim 80, wherein the third executable portion is adapted to compare the at least one value to at least one predefined goal reflecting at least one of at least one value associated with at least one other user, and at least one reference value.

82. A computer program product of monitoring at least one activity of a user, wherein the computer program product adapted to operate within a terminal, and wherein the computer program product comprises at least one computer-readable storage medium having computer-readable program code portions stored therein, the computer-readable program code portions comprising:
a first executable portion for driving a display to present a graphical representation of at least one quantitative goal of the user, wherein the at least one quantitative goal is related to an intensity with which the user performs the activity, and the graphical representation includes a plurality of sections, each section representing a successive percentage of the at least one goal;
a second executable portion for identifying when at least one value related to the at least one goal and an activity of the user meets each successive percentage of the at least one goal; and
a third executable portion for driving the display to alter a respective section of the graphical representation of the at least one goal in response to the user meeting the successive percentage.

83. A computer program product according to claim 82 further comprising:
a fourth executable portion for driving the display to present a numerical representation of the at least one value related to the at least one goal.

84. A computer program product according to claim 82, wherein the first executable portion is adapted to drive the display to present a graphical representation of a quantitative goal for a given time period, and wherein the computer program product further comprises:
a fourth executable portion for altering the time period and accordingly driving the display to present a graphical representation of the at least one goal for the altered time period.

85. A computer program product according to claim 82 further comprising:
a fourth executable portion for receiving a selection of an activity and acceleration measurement signals representative of movement of the user in performing an activity; and
a fifth executable portion for determining at least one value related to the at least one goal based upon the activity and the acceleration measurement signals.

86. A computer program product according to claim 85, wherein the fifth executable portion is adapted to identify a type of activity based upon the selected activity, and thereafter determine at least one value related to the at least one goal based upon the type of activity.

87. A computer program product according to claim 86, wherein the fifth executable portion is adapted to identify one of a duration activity, an intensity activity and a step activity.

88. A computer program product according to claim 86; wherein at least one quantitative goal is related to an energy expended by the user in performing the selected activity, and wherein the fifth executable portion is adapted to determine at least one value comprising the energy expended by the user in performing the selected activity based upon the selected activity and a duration over which the user performs the selected activity when the activity comprises a duration activity.

89. A computer program product according to claim 88, wherein the fifth executable portion is adapted to determining the energy expended by the user in performing the selected activity further based upon the intensity value when the activity comprises an intensity activity.

90. A computer program product according to claim 88, wherein the fifth executable portion is adapted to determining the energy expended by the user in performing the selected activity further based upon a speed of the user in performing the selected activity when the activity comprises a step activity.

91. A terminal for monitoring at least one activity of a user, the terminal comprising:
a connecting means for attaching the terminal onto a body of the user;
at least one acceleration sensor capable of measuring and providing acceleration measurement signals representative of movement of the user in performing an activity; and
a controller capable of operating an activity detection application, wherein the activity detection application is capable of receiving at least a portion of the measurement signals and determining at least one value related to the user performing the activity based upon the acceleration measurement signals, wherein the at least one value comprises an intensity value representing an intensity with which the user performs the activity, and an energy expended by the user in performing the activity, wherein the activity detection application is capable of determining the energy expended by the user based upon at least one of the intensity value, a duration over which the user performs the activity, and a speed of the user in performing the activity, and wherein the activity detection application is capable of determining the energy expended by the user independent of a nutritional intake of the user.

92. A terminal according to claim 91, wherein the activity detection application is capable of further receiving a selection of an activity, and wherein the activity detection application is capable of determining the at least one value further based upon the selected activity.
